(19) United States
(12) Patent Application Publication
(10) Pub. No.: US 2001/0051208 A1
(43) Pub. Date: Dec. 13, 2001

(54) Method of manufacturing phosphor screen of cathode ray tube

(76) Inventors: Seon-Young Kwon, Seoul (KR); Min-Ho Kim, Suwon-city (KR)

Correspondence Address: STAAS & HALSEY LLP, 700 11TH STREET, NW, SUITE 500, WASHINGTON, DC, 20001, US

(21) Appl. No.: 09/754,081

(22) Filed: Jan. 5, 2001

(30) Foreign Application Priority Data
Jan. 5, 2000 (KR) 2000-349

(51) Int. Cl. B05D 5/12; B05D 5/06

(52) U.S. Cl. 427/68

(57) ABSTRACT

A method of manufacturing a phosphor screen of a cathode ray tube for reducing required manufacturing process operations and time in comparison with a well-known slurry process, and preventing generation of noise due to smear of index stripes in a beam index type cathode ray tube. The method includes forming black matrix layers on a panel, transferring G color layers to the panel by scanning laser beams to a first transfer film having the G color layers as a transfer layer, transferring B color layers to the panel by scanning laser beams to a second transfer film having the B color layer as a transfer layer, transferring R color layers to the panel by scanning laser beams to a third transfer film having the G color layer as a transfer layer, forming an organic layer and an aluminum reflection layer on the whole surface of the panel, and removing the organic material by carrying out a baking process with relation to the panel.

### CROSS-REFERENCE TO RELATED APPLICATIONS

This application is based on Korean Application No. 2000-349, filed Jan. 5, 2000, in the Korean Patent Office, the disclosure of which is incorporated herein by reference.

### BACKGROUND OF THE INVENTION

1. Field of the Invention

The present invention relates to a method of manufacturing a phosphor screen of a cathode ray tube, and more particularly, to a method of manufacturing a phosphor screen of a cathode ray tube in which manufacturing operations and time may be reduced in comparison with a slurry process and it is possible to prevent generation of noise due to smear of index stripes in a beam index type cathode ray tube.

2. Description of the Related Art

In general, a cathode ray tube is a display device in which an electron gun generates, collects and accelerates electron beams, and scans the electron beams on a phosphor screen for radiating a phosphor substance, to obtain a picture. More particularly, a beam index type cathode ray tube performs the above functions by color lines by having index stripes in a phosphor screen instead of a shadow mask functioning as an electrode per color line in a general cathode ray tube.

FIG. 1 is a sectional view of a general beam index type cathode ray tube and FIG. 2 is a magnified sectional view of a phosphor screen. As shown in FIG. 1 and FIG. 2, a beam index type cathode ray tube includes a tube 3 having a phosphor screen 1 formed in the inside of a front portion thereof, an electron gun 7 mounted on the rear part of the tube 3 and emitting an electron beam 5, a deflection yoke 9 mounted on the outer peripheral surface of the tube 3 and deflecting the electron beam 5, light collecting plates 13 sensing an optical pulse reflected from index stripes 11, and photodirectors 15.

The phosphor screen 1 is formed with red R, green G and blue B phosphor stripes 19 serially formed between black matrix layers 17, an aluminum reflection layer 21, and index stripes 11 formed on the aluminum reflection layer 21 at an arbitrary interval.

If the electron gun 7 emits the electron beam 5, the electron beam 5 generates an optical pulse by exciting the index stripes 11, the optical pulse is detected in the photodirectors 15 through the light collecting plates 13 and converted into an index signal. The index signal emits an exact color signal by being synchronized with a color signal in an index circuit for obtaining the desired color.

As above, for functions by color lines, all phosphor screens of a general cathode ray tube and the phosphor screen of the beam index type cathode ray tube including the index stripes 11 are manufactured through a general slurry process.

FIGS. 3A through 3F are schematic views showing a manufacturing process of a related art phosphor screen. A panel 23 is washed and black matrix layers 17 are formed by the well-known photolithography process as shown in FIG. 3A. A G phosphor substance slurry is applied on the whole panel 23 and cured by partially exposing, and then the rest slurry, which is not cured, is removed by developing, so that G phosphor stripes 19G are completed as shown in FIG. 3B. B phosphor stripes 19B and R phosphor stripes 19R are formed in the same manner as the G phosphor stripes 19G, as shown in FIGS. 3C and 3D.

Thereafter, as shown in FIG. 3E, an organic layer 25 is formed on the black matrix layers 17 and the phosphor stripes 19G, 19B and 19R, and a thin aluminum reflection layer 21 is formed by evaporatingly diffusing aluminum under vacuum. In the case of the beam index type cathode ray tube, a protection layer (not shown) is formed on the aluminum reflection layer 21, the index phosphor substance slurries are applied on the protection layer, then the index stripes 11 are formed by partially exposing and developing at a regular interval.

After forming the index stripes 11, the panel 23 is put into a baking furnace of a high temperature over 400. Through the baking process, organic materials such as the organic layer 25 and the protection layer are decomposed, so that a final phosphor screen is completed, as shown in FIG. 3F.

However, in the related art phosphor screen, all individual phosphor screen stripes and especially the index stripes are manufactured by the slurry process including the operations of applying, drying, exposing and developing of slurries, and therefore, there are problems that the whole process becomes complicated and the manufacturing time period becomes increased.

Likewise, since it is impossible to obtain an excellent screen quality with the slurry process, the index stripes may remain at undesired positions after developing, or are formed with a width larger than that of the black matrix layers in the beam index type cathode ray tube. In this case, a resolution of the cathode ray tube becomes degraded, since an exact screen may not be constructed due to noise signals generated during the operation of the cathode ray tube.

### SUMMARY OF THE INVENTION

It is an object of the present invention is to provide a method of manufacturing a phosphor screen of a cathode ray tube, in which manufacturing operations and time may be reduced in comparison with a slurry process by forming a phosphor screen and index stripes by a laser transfer method.

Another object of the present invention is to provide a method of manufacturing a phosphor screen of a cathode ray tube, in which an excellent resolution may be obtained in comparison with the slurry process and it is possible to prevent generation of noise due to the smear of index stripes in a beam index type cathode ray tube.

Additional objects and advantages of the invention will be set forth in part in the description which follows and, in part, will be obvious from the description, or may be learned by practice of the invention.

In order to achieve the above and further objects and advantages of the present invention, a method of manufacturing a phosphor screen of a cathode ray tube includes forming black matrix layers on a panel, transferring green G color layers to the panel by scanning laser beams to a first transfer film having the G color layers, transferring blue B color layers to the panel by scanning the laser to a second transfer film having the B color layers, transferring red R color layers to the panel by scanning the laser to a third transfer film having the R color layers, forming an organic layer and an aluminum reflection layer on the whole surface of the panel, and removing organic substances by performing a baking process with relation to the panel.

According to the present invention as above, the phosphor screen is formed in a substantially flat board shape advantageously for the laser transferring process and the above method further includes transferring an index phosphor layer on the aluminum reflection layer by scanning the laser to a fourth transfer film having the index phosphor film as a transfer layer after forming the aluminum reflection layer.

Therefore, the present invention constructed as above has advantages that degradation of resolution due to the generation of noise may be restrained by effectively preventing the smear of the index stripes and that the manufacturing operations and time may be reduced by forming the R, G and B phosphor layers and the index stripes in exact patterns by a laser transfer method.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings wherein:

FIG. 1 is a schematic view of a related art general beam index type cathode ray tube;

FIG. 2 is a magnified sectional view of the related art phosphor screen shown in FIG. 1;

FIGS. 3A through 3F are schematic views showing a related art method for manufacturing a phosphor screen shown in FIG. 1;

FIG. 4 is a procedural view showing a method of manufacturing a phosphor screen according to the present invention;

FIGS. 5 to 12 are schematic views respectively showing a process for manufacturing a phosphor screen according to the present invention; and

FIG. 13 is a cross-sectional view of a beam index type cathode ray tube according to the present invention.

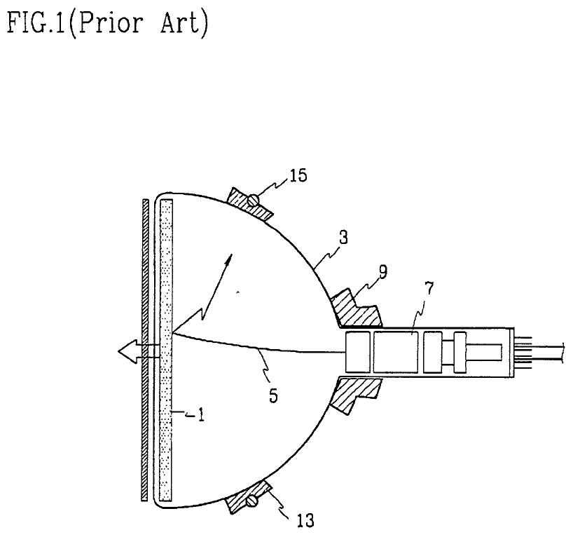

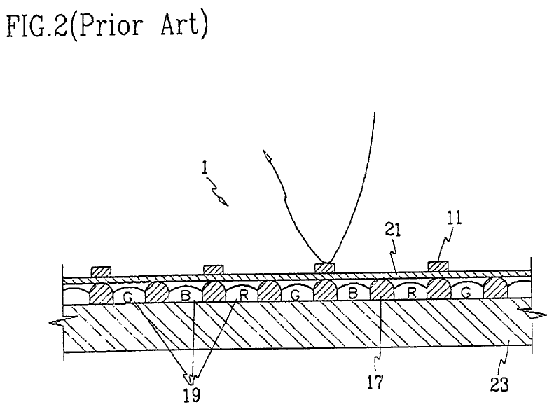

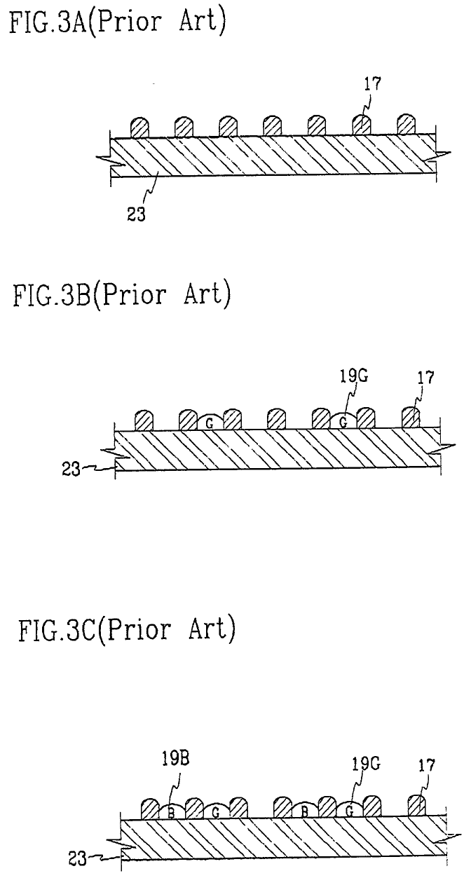

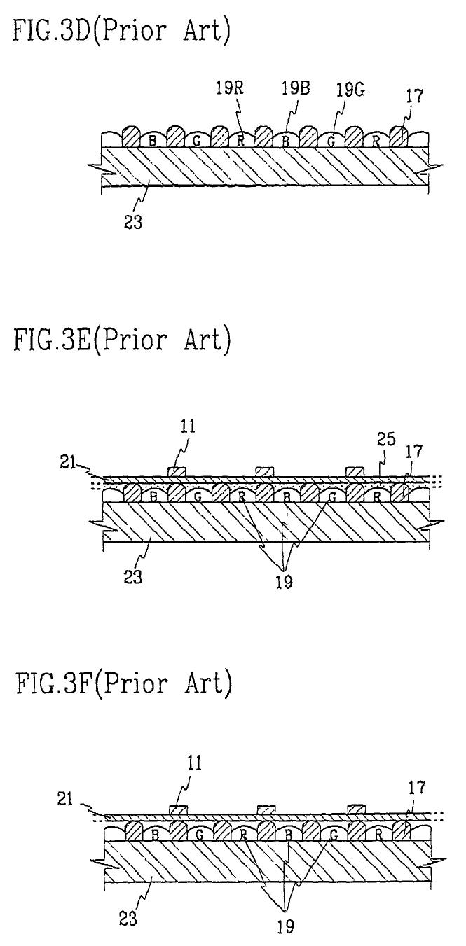

### DETAILED DESCRIPTION OF THE INVENTION

Reference will now be made in detail to the preferred embodiments of the present invention, examples of which are illustrated in the accompanying drawings, wherein like reference numerals refer to like elements throughout.

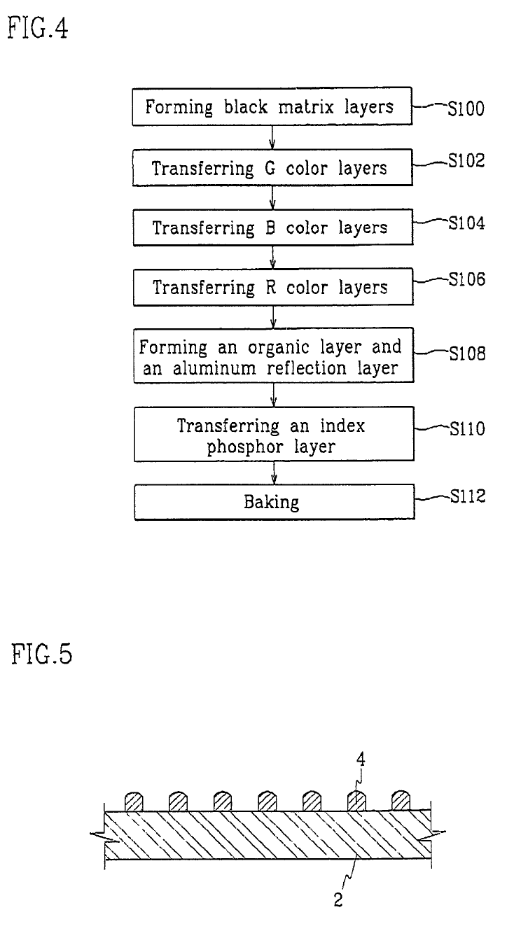

FIG. 4 is a flow chart showing a method of manufacturing a phosphor screen according to an embodiment of the present invention, which includes the operation of forming black matrix layers (S100), transferring green G (S102), blue B (S104) and red R (S106) color layers to a panel by using transfer films and a laser, forming an organic layer and an aluminum reflection layer on the whole surface of the panel (S108), transferring an index phosphor layer to the panel by using a transfer film and the laser (S110), and baking (S112).

First, as set forth in S100, a panel 2 is washed for manufacturing a phosphor screen and black matrix layers 4 are formed by a well-known photolithography process (referring to FIG. 5). The black matrix layers 4 are made of light absorbing materials such as black lead and function to improve degrees of resolution and color purity of a screen by separating respective phosphor stripes.

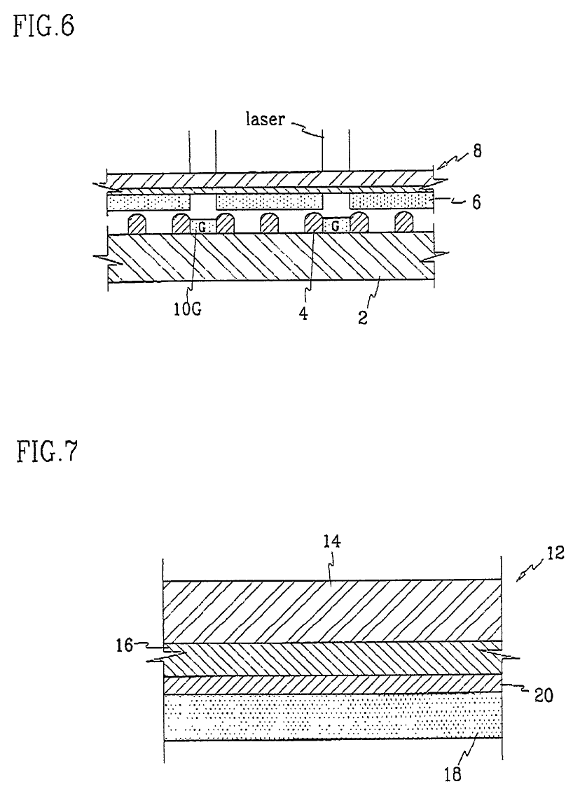

After forming the black matrix layers 4, as shown in FIG. 6, a first transfer film 8 having the G color layers 6 as a transfer layer is arranged on the panel 2, several laser beams are scanned from one end toward the opposite end of the first transfer film 8, such that G color layers 6 of a part receiving the scanned laser beams are selectively transferred to the panel 2 for forming G phosphor stripes 10G (S102). Then the first transfer film 8 is removed.

As above, the laser transfer method is a main principle, in which a pigment phosphor complex coated on the transfer films by such laser beam scanning is transferred to a substrate, forming a pattern on the substrate. Concrete composition of the transfer films is shown in FIG. 7. As shown in FIG. 7, a transfer film 12 includes a transparent supporting layer 14, a light to heat convertible layer 16, and a transfer layer 18 (a typical color layer).

The supporting layer 14 serves as a supporting member of the transfer film 12 and is formed with a macromolecular film having an excellent transparency, such as polyester, polyacrylate, epoxy resin, polyethylene, polypropylene, polystyrene, and the like, and mainly formed with a polyethylene terephthalate (PET) film.

The light to heat convertible layer 16 converts light energy to thermal energy, and contains substances generating gas or to be melted by heat, so as to form a pattern by transferring the transfer layer 18 to the substrate by expansion of the gas or adhering the transfer layer 18, of which viscosity is increased by the heat, to the substrate. The light to heat convertible layer 16 may be made of acrylate resin crosslinked by adding a carbon pigment and photoinitiators in an acryl monomer and then carrying out optical reaction, for example.

An interim layer 20 may be introduced between the light to heat convertible layer 16 and the transfer layer 18 for preventing the contamination of the transfer layer 18.

After forming the G phosphor stripes 10G using the transfer film and the laser and removing the first transfer film 8, as shown in FIG. 8, a second transfer film 24 having B color layers 22 as a transfer layer is arranged on the panel 2, laser beams are scanned to the panel 2 for transferring the B color layers 22, such that B phosphor stripes 10B are formed (S104). Then the second transfer film 24 is removed.

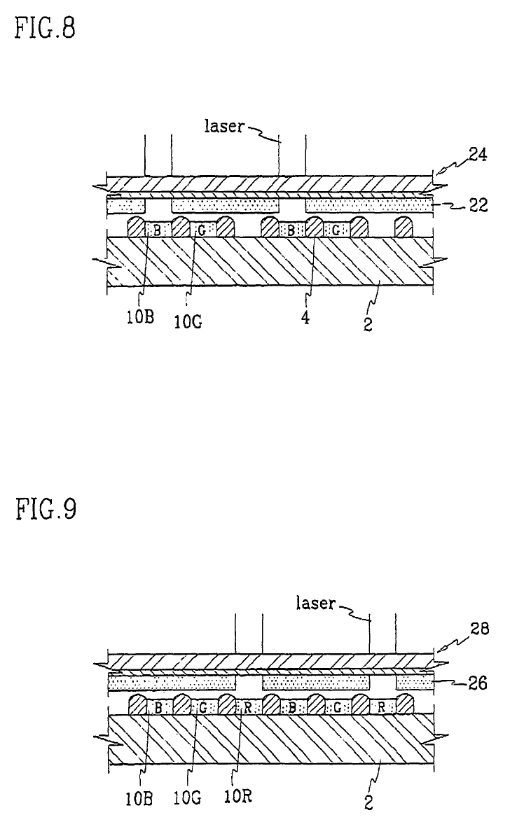

In the same manner as described above, a third transfer film 28 having R color layers 26 as a transfer layer is arranged on the panel 2, and laser beams are scanned on the panel 2 for forming R phosphor stripes 10R, as shown in FIG. 9 (S106).

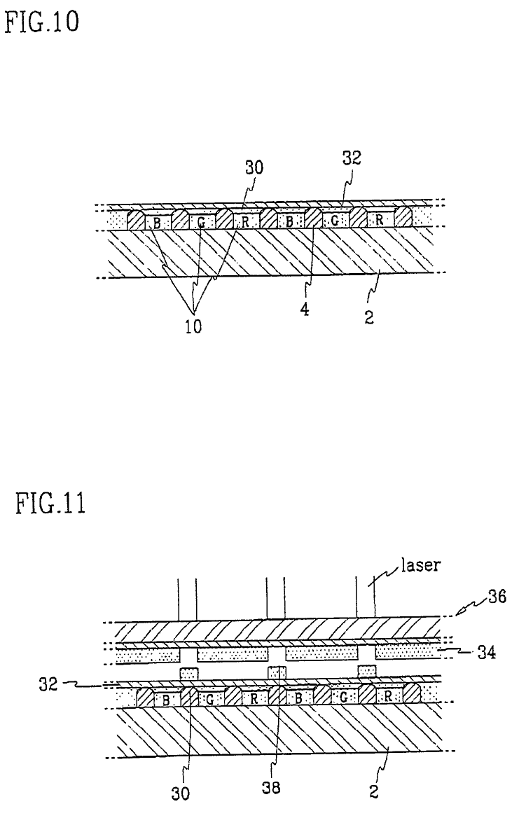

Thereafter, as shown in FIG. 10, an organic layer 30 is formed by applying and drying a filming solution on the whole surface of the panel 2, on which the black matrix layers 4 and the R, G and B phosphor layers 10 are formed, and a thin aluminum reflection layer 32 is formed by evaporatingly diffusing an aluminum to the surface of the organic layer under vacuum (S108).

The organic layer 30 improves the reflection efficiency of the aluminum reflection layer 32 by planarizing the aluminum reflection layer 32 and the aluminum reflection layer 32 prevents the potential drop of the phosphor screen by moving electrons accumulated on the phosphor screen, thereby improving the brightness of the phosphor screen.

In the case of the beam index type cathode ray tube, as shown in FIG. 11, a fourth film 36 having index phosphor layers 34 as a transfer layer is arranged on the panel 2, and laser beams are scanned for forming index stripes 38 on the aluminum reflection layer 32 (S110). As the index stripes 38 exactly remain only in the part where the laser beams are scanned, the index stripes 38 can solve the smear problem.

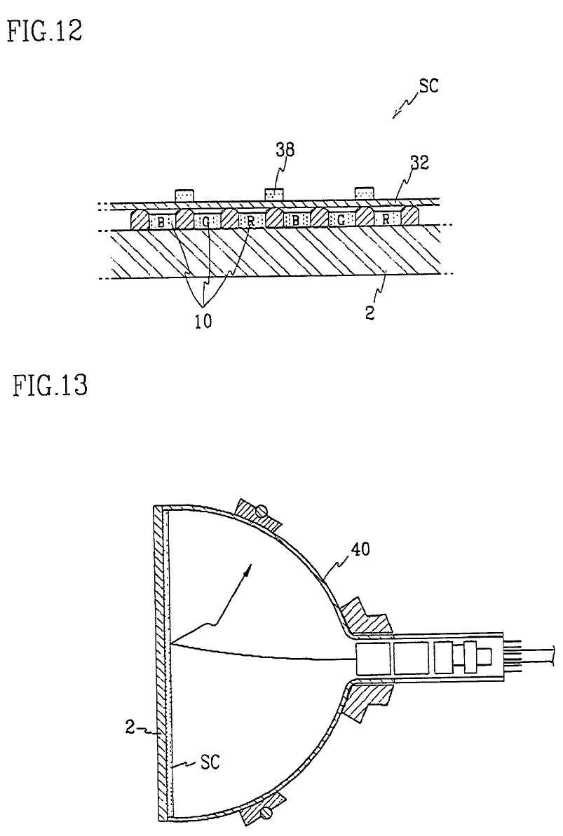

After forming the index stripes 38 with the above described procedure, the organic substances including the organic layer 30 are removed by putting the panel 2 into a baking furnace, thereby completing a phosphor screen SC, as shown in FIG. 12 (S112). Generally, the organic layer is heat-decomposed in the baking process so that decomposing gas is exhausted through pores of the aluminum layer.

At this time, it is desirable that the panel 2, in which the phosphor screen is formed, is made in a substantial flat board shape without a side wall to easily perform a phosphor screen manufacturing process by the laser transfer method as shown in FIGS. 4 through 12 and a funnel 40 is preferably formed extendedly toward the edge of the panel 2 as shown in FIG. 13.

It is preferable to make the panel 2 in the flat board shape, since it is difficult to arrange the transfer films and perform the smooth scanning of laser beams in a panel having a certain curvature and the side walls formed at four edges. Further, it is difficult to perform a perfect transfer due to the difficulty of exhaust between the transfer films and the panel.

As described above, if the phosphor stripes 10G, 10B and 10R and the index stripes 38 are formed by the laser transfer method, the pattern formation is completed by the laser transfer method and it becomes possible to efficiently reduce the manufacturing process and time required for forming the respective stripes.

Further, there are advantages that the size of the stripes may be easily controlled by adjusting a diameter of laser beams, the quality of the phosphor screen may be improved by forming the stripes in the part where the laser beams are scanned, and generation of noise due to smear of an index stripe and the degradation of the resolution of a cathode ray tube may be prevented.

As above described hereinabove, a method of manufacturing a phosphor screen of a cathode ray tube according to the present invention is characterized in that the R, G and B phosphor stripes and index stripes are formed by a laser transfer method, such that more excellent resolution may be obtained with exact patterning of the respective phosphor stripes and the index stripes on parts where the laser beams are scanned, the width of the respective stripes may be controlled by adjusting the diameter of the laser beams, generation of noise due to the smear of the index stripes may be prevented, and the manufacturing process and time required for manufacturing the whole phosphor screen may be effectively reduced.

It will be apparent to those skilled in the art that various modifications and variations can be made to the device of the present invention without departing from the spirit and scope of the invention. The present invention covers the modifications and variations of this invention provided they come within the scope of the appended claims and their equivalents.

What is claimed is:

1. A method of manufacturing a phosphor screen of a cathode ray tube comprising:
forming black matrix layers on a panel;
transferring green G color layers to the panel by scanning laser beams to a first transfer film having the G color layers;
transferring blue B color layers to the panel by scanning laser beams to a second transfer film having the B color layers;
transferring red R color layers to the panel by scanning the laser beams to a third transfer film having the R color layers;
forming an organic layer and an aluminum reflection layer on the whole surface of the panel; and
removing the organic layer by carrying out a baking process with relation to the panel.

2. The method of claim 1, further comprising:
transferring index phosphor layers on the aluminum reflection layer by scanning the laser beams to a fourth transfer film having the index phosphor layers after forming the aluminum reflection layer.

3. The method of claim 1, wherein the panel, on which the phosphor screen is to be formed, is made in a substantially flat board shape.

4. The method of claim 1, wherein each of the first through third transfer films comprises a transparent supporting layer, a light to heat convertible layer for converting light energy to thermal energy, and transfer layers to be transferred to the panel.

5. The method of claim 1, wherein each of the first through third transfer films comprises, in order, a transfer layer from which the corresponding green G color layers, blue B color layers and red R color layers are formed, an interim layer, a light to heat convertible layer for converting light energy to thermal energy, and a transparent supporting layer, wherein the interim layer prevents contamination of the transfer layer by the light to heat convertible layer.

6. The method of claim 4, wherein the transparent supporting layer is made of a polyethylene terephthalate (PET) film.

7. The method of claim 4, wherein the transparent supporting layer is a macromolecular film made of one of a group consisting essentially of polyester, polyacrylate, epoxy resin, polyethylene, polypropylene, and polystyrene.

8. The method of claim 4, wherein the light to heat convertible layer is made of acrylate resin crosslinked by adding a carbon pigment and photoinitiators to an acryl monomer and then carrying out an optical reaction.

9. The method of claim 1, wherein the transferring of the green G color layers, the blue B color layers and the red R color layers each comprises:
generating gas or melting parts of the corresponding first through third transfer films by scanning the laser beams, so as to transfer the corresponding green G color layers, the blue B color layers and the red R color layers to the substrate by expansion of the gas or adhering the melted parts of the corresponding first through third transfer films.

10. The method of claim 1, wherein the forming of the organic layer comprises:
applying and drying a filming solution on the whole surface of the panel including the green G color layers, the blue B color layers and the red R color layers, to form the organic layer.

11. The method of claim 10, wherein the forming of the aluminum reflection layer comprises:
evaporatingly diffusing an aluminum to a surface of the organic layer under vacuum, to form the aluminum reflection layer.

12. A method of manufacturing a phosphor screen of a cathode ray tube, comprising:
forming black matrix layers on a panel;
transferring green G color layers, blue B color layers and red R color layers from corresponding first through third transfer films to the panel between the black matrix layers using a laser transferring method.

13. The method of claim 12, further comprising:
forming an organic layer and an aluminum reflection layer on the panel including the green G color layers, blue B color layers and red R color layers; and
removing the organic layer using a baking process.

14. The method of claim 13, further comprising:
transferring index phosphor layers on the aluminum reflection layer after forming the aluminum reflection layer on the organic layer.

15. The method of claim 12, wherein each of the first through third transfer films comprises, in order, a transfer layer from which the corresponding green G color layers, blue B color layers and red R color layers are formed, a light to heat convertible layer for converting light energy to thermal energy, and a transparent supporting layer.

16. The method of claim 15, wherein the transparent supporting layer is a macromolecular film made of one of a group consisting essentially of polyester, polyacrylate, epoxy resin, polyethylene, polypropylene, and polystyrene.

17. The method of claim 12, wherein the transferring of the green G color layers, the blue B color layers and the red R color layers each comprises:
generating gas or melting parts of the corresponding first through third transfer films by scanning laser beams on positions of the transport supporting layer corresponding to positions on the panel, so as to transfer the corresponding green G color layers, the blue B color layers and the red R color layers to the positions on the substrate by expansion of the gas or adhering the melted parts of the corresponding first through third transfer films.

18. The method of claim 17, further comprising adjusting diameters of the scanning laser beams to adjust widths of the green G color layers, the blue B color layers and the red R color layers.

19. The method of claim 13, wherein the forming of the organic layer comprises:
applying and drying a filming solution on the whole surface of the panel including the green G color layers, the blue B color layers and the red R color layers, to form the organic layer.

20. The method of claim 19, wherein the forming of the aluminum reflection layer comprises:
evaporatingly diffusing an aluminum to a surface of the organic layer under vacuum, to form.

21. A method of manufacturing a phosphor screen, comprising:
forming G, B and R phosphor stripes on a panel using a laser transfer method; and
forming a reflection layer surface over the panel; and
forming index stripes on the reflection layer surface using the laser transfer method.

22. The method of claim 21, wherein the forming of the reflection layer surface comprises:
forming an organic layer over the panel including the G, B and R phosphor stripes;
forming the reflection layer surface on the organic layer; and
removing the organic layer through a baking process.

23. The method of claim 22, wherein the reflection layer surface is made of aluminum.
